(19) United States
(12) Patent Application Publication
(10) Pub. No.: US 2003/0053939 A1
(43) Pub. Date: Mar. 20, 2003

(54) Baffle plate for single flow channel reactors

(76) Inventors: Lance L. Smith, North Haven, CT (US); Shahrokh Etemad, Trumbull, CT (US); Hasan UI Karim, Hamden, CT (US); Marco Castaldi, Bridge Port, CT (US)

Correspondence Address: McCormick, Paulding & Huber, City Place II, 185 Asylum Street, Hartford, CT, 06103-3402, US

(21) Appl. No.: 09/953,137

(22) Filed: Sep. 15, 2001

(51) Int. Cl. B01J 8/00

(52) U.S. Cl. 422/176; 422/177

(57) ABSTRACT

The invention disclosed herein is a flow baffle for providing a generally uniform flow to a fluid within a catalytic reactor, which is characterized by a single flow channel. The invention, however, has general application to any single flow channel device. The flow baffle is inserted within the reactor in the single flow channel to cause the fluid flowing in the single flow channel to have a generally uniform flow field, instead of preferentially flowing down a periphery of the channel. The uniform flow field promotes the design optimization of the catalytic reactor.

### FIELD OF THE INVENTION

The present invention is generally directed to conditioning a flow within a flow channel having obstructions therein, and more specifically to a baffle plate that is positioned within the flow channel of a catalytic reactor.

### BACKGROUND OF THE INVENTION

The present invention has general utility with respect to flow channels that have obstructions positioned therein and is particularly useful in catalytic reactors having a single catalytic flow channel defined in part by a plurality of tubes. One such catalytic reactor is depicted in U.S. patent application Ser. No. 09/527,708 (hereinafter the '708 application), the disclosure of which is incorporated in its entirety herein by reference. The '708 application has a common inventor with the present application, and is assigned to the assignee of the present invention, namely, Precision Combustion, Inc of North Haven, Conn. However, while the catalytic reactor described and illustrated herein is particularly suitable for use with the present invention, it should be understood that the invention is not limited in this regard as the invention could be used with other structures having a single flow channel.

The catalytic reactor described in the '708 application employs a single catalytic flow channel created by placing a plurality of tubes within a housing such that the tubes, collectively referred to as a bundle, are separated, one from the other, and from the housing. Each tube has an outside surface a portion of which is within the single flow channel and at least one outside surface has a catalyst positioned on some portion thereof. The single flow channel is defined by the exterior surfaces of the tubes and the housing. More specifically, the housing has an inner surface that defines the periphery of the single flow channel. The structure of the catalytic reactor allows a first fluid to enter the single flow channel and a second fluid to enter the tubes, but prevents the first fluid from entering the tubes and the second fluid from entering the single flow channel.

A problem with a catalytic reactor configured in the above-described manner is that the tubes are obstructions within the single flow channel. Consequently when a first fluid enters the single flow channel, it has a tendency not to develop a uniform flow distribution across the single flow channel; the first fluid does not enter the bundle uniformly. This causes the first fluid to flow primarily along the periphery of the bundle along the inner surface of the housing causing under utilization of the catalyst.

This problem is exacerbated the larger the bundle. For example in a seven tube hexagonal-packed catalytic reactor, the flow non-uniformity within the bundle is negligible, thus temperatures of the tubes during operation resulting from catalytic activity are relatively similar. However, when the size of the reactor is increased from 7 tubes to 306 tubes, positioned in 17 rows, the tubes on the outer periphery of the bundle operate significantly hotter than those located toward the middle of the bundle, as a result of the non-uniform flow.

This non-uniform flow of the first fluid within the bundle can lead to under utilization of the catalyst or even non-uniformity in the catalytic reaction. Where the catalyzed reaction is exothermic, non-uniform flow patterns can cause such undesirable effects as hot spots (local heating to temperatures well in excess of the average reaction temperature). As the hot spot temperature is higher than desired, materials from which the reactor is constructed can be unduly stressed. Therefore, due to material limitations of both the catalyst and the tubes (i.e. the substrate), additional margin in the catalyst and tube material must be incorporated into the reactor.

Based on the foregoing, it is the general objective of the present invention to provide a reactor that overcomes the problems and drawbacks associated with known reactors.

### SUMMARY OF THE INVENTION

The present invention resides in one aspect to a catalytic reactor wherein a housing defines an interior area and an inlet in fluid communication therewith. The inlet is adapted to receive a first fluid. A plurality of tubes is positioned in the interior area, each defining an exterior surface and an inlet for receiving a second fluid exclusive of the first fluid. The tubes in cooperation with the interior area define a single flow channel through which, during operation, the first fluid, exclusive of the second fluid, passes. A catalyst is positioned within the flow channel on the exterior surface of at least one of the tubes. The flow baffle is positioned within the interior area upstream of at least some of the catalyst for providing a uniform first fluid flow through any remaining portion of the flow channel.

In a catalytic reactor of the above-described type, the first fluid must pass over tubes located near the reactor's inlet before it can contact tubes near the reactor's center. As a result, there is a tendency for the first fluid to flow primarily along tubes located nearer to the reactor's inlet, following the path of least resistance. The flow baffle introduces an additional and greater flow resistance, so that all flow paths have similar resistance and the flow of first fluid through the reactor becomes more uniform.

Preferably, the flow baffle is in the form of a plate that defines a plurality of apertures, each having a peripheral surface extending therethrough. An aperture can have none or one or more tubes passing therethrough. Where a tube or tubes pass through an aperture, if the first fluid is intended to also pass through the aperture then the aperture must be oversized. If the peripheral surface of the aperture engages the tube(s) extending therethrough, passage of the first fluid flowing in the single flow channel through that aperture is prevented. Where all of the apertures have tube(s) passing therethrough, some apertures must be oversized. By properly sizing the apertures, the flow resistance within the single flow channel can be modified to provide a generally uniform flow for a fluid flowing therethrough. A generally uniform flow being defined as one that makes the flow of a fluid over the catalyst generally uniform, such that the reaction at any given location is roughly equivalent to the reaction at any other location.

The housing is defined in part by an interior area the cross-section of which is modified by the flow baffle and the apertures extending therethrough. Each aperture also defines a cross-section through which the first fluid can flow if not blocked by one or more tubes extending through the aperture. By individual sizing of the cross-sections of the apertures, the cross-sections defined thereby cooperate to make the flow of the first fluid through the single flow channel generally uniform. The size of the apertures is based on the location of the aperture, thus apertures can be sized to varying degrees (i.e. graded) tending to be larger toward the center of the bundle, if desired.

While the invention has been illustrated with tubes, the invention should not be considered limited to structures having circular cross-sections. It should also be understood that the pattern of the tubes within the housing is for illustration only and is not to be considered a limitation of the invention.

### DESCRIPTION OF THE DRAWINGS

FIG. 1 is a schematic view generally showing a catalytic reactor with a cut away to show representative tubes inside the reactor.

FIG. 2 is a cross-sectional view taken along the longitudinal centerline of the reactor of FIG. 1 with a first embodiment of the present invention positioned therein.

FIG. 3 is a section of the reactor of FIG. 2 showing a front view of the first embodiment of the present invention.

FIG. 4 is a cross-sectional view taken along the longitudinal centerline of the reactor of FIG. 1 with a second embodiment of the present invention positioned therein.

FIG. 5 is a section of the reactor of FIG. 4 showing a front view of the second embodiment of the present invention.

### DETAILED DESCRIPTION

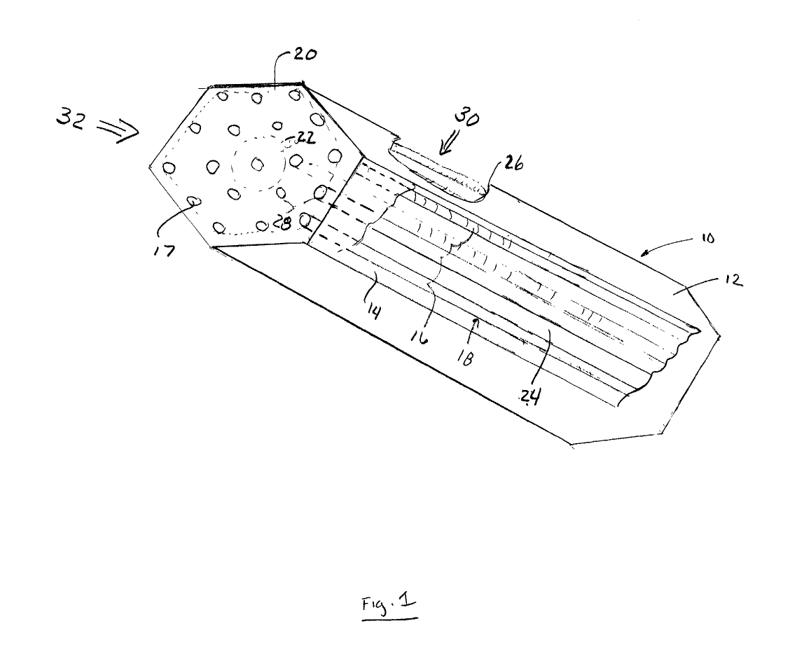

As shown in FIG. 1, a catalytic reactor, generally referred to by reference 10, comprises a housing 12 defining an inner area 14 with a plurality of tubes 16, collectively referred to as a bundle 18, positioned therein. The bundle 18 defines a periphery 20, denoted by dotted lines, having a center region 22, also denoted by dotted lines. The tubes 16, each having an inlet 17, and the housing 12 cooperate to define a single flow channel 24. The housing 12 defines an inlet 26 and a plurality of passages 28.

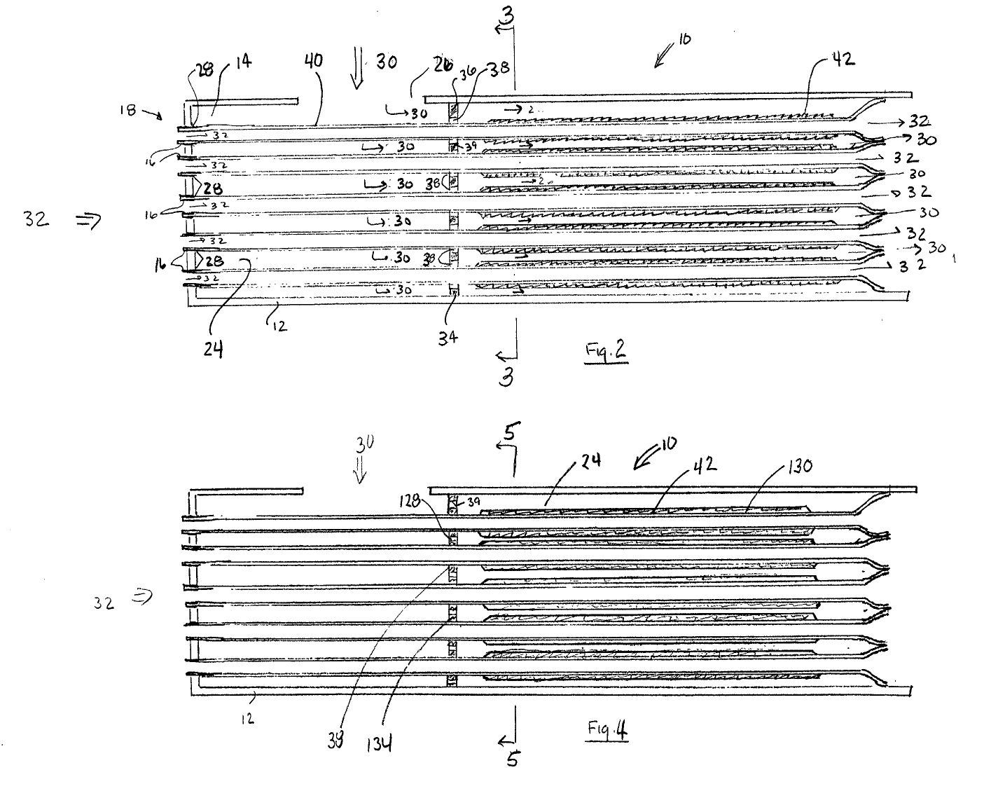

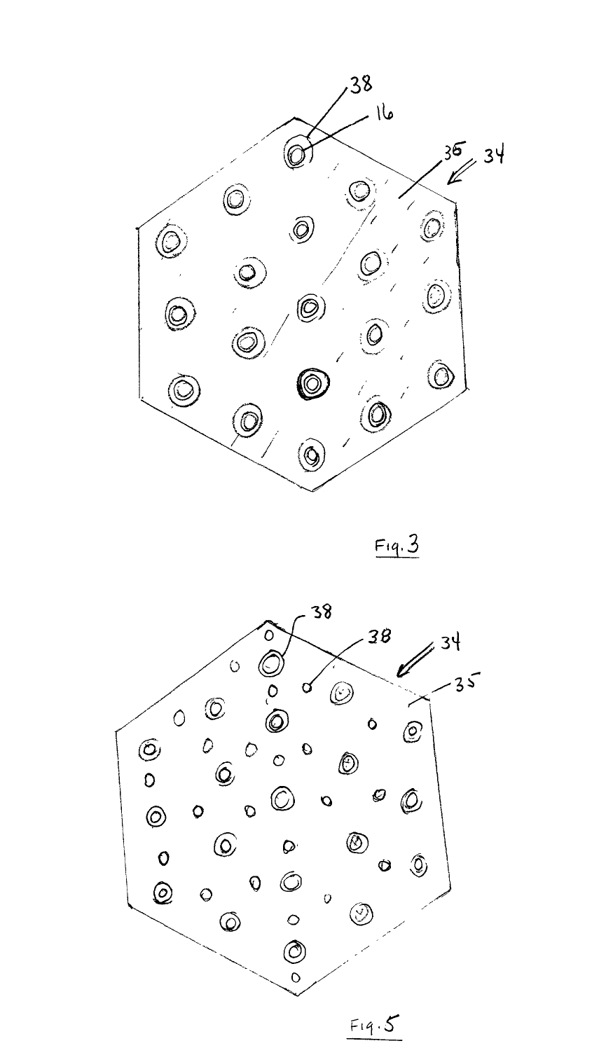

A tube 16 sealably passes through the passage 28, such that there is no fluid communication between the outside of the catalytic reactor 10 and the single flow channel 24 through the passages 28. This structure isolates a first fluid 30 that enters the single flow channel 24 through inlet 26 from a second fluid 32 that enters each tube through entrance 17. The single flow channel 24 ends at a point where the first fluid 30 and the second fluid 32 can mix (see FIGS. 2 and 4).

FIG. 2 shows a baffle plate 34 of the first embodiment positioned spatially downstream, based on the normal flow of a first fluid 30 within the single flow channel 24, from inlet 26. The baffle plate 34 is a plate 36 that defines a plurality of apertures 38, each having a peripheral surface 39. The tubes 16, each having an exterior surface 40, are distributed among and pass through the apertures 38. While a single tube 16 is shown passing through an aperture 38 this is not required as the aperture 38 could be sized to accommodate more than one tube 16; thus the invention should not be considered so limited. FIG. 3 more clearly shows the apertures 38 with the tubes 16 passing therethrough.

Continuing with FIG. 2, in the catalytic reactor10, a catalyst 42 is positioned on at least some of the exterior surfaces 40 of the tubes 16 within the single flow channel 24. The catalyst 42 is positioned at the surface 40, therefore other methods such as alloying of the catalyst into a substrate are considered within the scope of the invention. The catalyst 42 need not be on each tube 16. It is preferred, however, that the baffle plate 34 be positioned within the single flow channel 24 spatially upstream of all the catalyst 42.

The tubes 16 are depicted as having a uniform cross section and being uniformly packed (specifically hexagonal) within the inner area 14. Uniform cross-sections and packing of the tubes 16 should not be considered a limitation of the invention. The term tube as used herein means only a closed structure that confines a flow. In addition, a tube 16 is considered to include a multi-channeled structure.

In this depiction, all apertures 38 have a cross section that is oversized relative to the tube 16 passing therethrough. This, however, is not required as some apertures 38 could engage the tube 16, or tubes 16, passing therethrough. In the case were all apertures 38 have tube(s) 16 passing therethrough, some apertures 38 must be oversized.

Referring to FIG. 1 and FIG. 2, the size of any particular aperture 38 is determined based on the pressure drop from the periphery 20 to the center region 22 of the bundle 18. Preferably, the apertures 38 are oversized as necessary to create a pressure drop at least equal to the pressure drop from the periphery 20 to the center region 22, thereby making it equally desirable for the first fluid 30 flowing through the single flow channel 24 to flow down the periphery 20 or the center region 22 of the bundle 18. Simplistically, all the apertures 38 could be of the same size; however, it is possible to change the size of, or grade, the apertures 38 to more accurately reflect the pressure gradient within the bundle 18. The pressure drop from the periphery 20 to the center region 22, or any other location within the bundle 18, of any given bundle 18 at the desired flow conditions can be determined by experimentation or calculation.

Continuing with FIG. 3, the depicted apertures 38 are circular in cross section and concentric with tubes 16, which also have a circular cross-section, passing therethrough; circular cross-sections of apertures 38 or tubes 16 are merely illustrative and should not be considered a limitation of the invention as other cross-sections regular and irregular and positioning could be employed. It is also not a requirement of the present invention that the apertures 38 have the same or similar cross-section to the tube 16 passing therethrough.

FIG. 4 is a second embodiment of the baffle plate 34. The catalytic reactor 10 is the same as that depicted in FIG. 1 and FIG. 2 except none of the apertures 38 is oversized relative to the tube(s) 16 passing therethrough. Instead, some apertures 38 have no tube 16 passing therethrough. FIG. 5 better shows the distribution of apertures 38 in the plate 35. This embodiment allows greater flexibility, as aperture 38 placement is independent of tube(s) 16 placement. These apertures 38 can also be of varying sizes.

As those skilled in the art of reactor design will appreciate, there is a third embodiment of the present invention that is a combination of the first and the second embodiments. In other words, it is possible to use a combination of apertures without tubes passing therethrough and apertures with tubes passing therethrough that are oversized. This embodiment is considered within the scope of the invention.

Referring back to FIGS. 2 and 4, the catalyst 42 can be any catalyst composition selected to promote the desired reaction of the first fluid 30, which can either cause an exothermic or endothermic reaction. Those skilled in the art of catalytic reactor design generally know how a given catalyst composition interacts, exothermically or endothermically, with a given first fluid 30. As those skilled in the art appreciate, there are numerous methods for positioning the catalyst 42 on the surface 40 including but not limited to depositing, such as by dipping or deposition, and incorporation of the catalyst 42 into the tube 16. It is preferred that the catalyst 42 be positioned on the surface 40 of tube, or tubes, 16 downstream of the flow baffle 34. It is not a requirement of the present invention, however, that catalyst is positioned on each tube 16, and the invention should not be considered so limited.

Although the present invention has been described in considerable detail with reference to certain preferred versions, thereof, other versions are possible. Therefore, the spirit and scope of the appended claims should not be limited to the description of the preferred versions contained herein.

What we claim is:

1. A catalytic reactor comprising:
a housing defining an interior area and an inlet adapted to allow a first fluid to pass therethrough, the inlet being in fluid communication with the interior area;
a plurality of tubes positioned in the interior area, each having an exterior surface and defining an inlet positioned to receive, during operation of the reactor, a second fluid exclusive of the first fluid;
the plurality of tubes and the interior area cooperating to define a flow channel through which during operation the first fluid exclusive of the second fluid will flow;
a catalyst positioned within the flow channel on the exterior surface of at least one tube; and
a baffle positioned within the flow channel upstream of the catalyst for creating a generally uniform flow in the first fluid in response to the first fluid flowing through the flow channel.

2. The catalytic reactor of claim 1 wherein the baffle defines a plurality of apertures at least a portion of which have at least one of the tubes passing therethrough.

3. The catalytic reactor of claim 2 wherein at least a portion of the plurality of apertures have at least one of the tubes passing therethrough and wherein the aperture is oversized relative to the tube passing therethrough.

4. The catalytic reactor of claim 3 where the apertures are graded.

5. The catalytic reactor of claim 4 wherein each tube has an exit cooperating with the interior area to define an outlet from the flow channel.

6. The catalytic reactor of claim 2 wherein a portion of the plurality of apertures having at least one of the tubes passing therethrough defines a peripheral surface that engages the tube.

7. The catalytic reactor of claim 2 wherein all of the apertures have at least one tube passing therethrough and at least one of the apertures is oversized relative to the tube.

8. The catalytic reactor of claim 7 wherein all the apertures are oversized.

9. The catalytic reactor of claim 8 wherein the apertures are graded.

10. A method of using a flow baffle to condition a flow in a catalytic reactor comprising:
providing a catalytic reactor having a housing defining an interior area and an inlet adapted to allow a first fluid to pass therethrough, the inlet being in fluid communication with the interior area; a plurality of tubes positioned in the interior area, each defining an inlet positioned to receive during operation a second fluid exclusive of the first fluid and an exterior surface; the plurality of tubes and the interior area cooperating to define a flow channel through which during operation the first fluid exclusive of the second fluid will flow; and a catalyst positioned within the flow channel on the exterior surface of at least one tube; and
positioning a flow baffle within the flow channel whereby the flow of the first fluid therethrough is generally uniform.

11. The method of claim 10 wherein the baffle defines a plurality of apertures and some of the plurality of apertures have at least one of the tubes passing therethrough.

12. The method of claim 11 wherein at least one of the apertures is oversized relative to the at least one tube passing therethrough.

13. The method of claim 12 where the apertures are graded.

14. The method of claim 4 wherein each tube has an exit cooperating with the interior area to define an outlet from the flow channel.
